(19) United States
(12) Patent Application Publication
(10) Pub. No.: US 2024/0066965 A1
(43) Pub. Date: Feb. 29, 2024

(54) VEHICLE ROOF STRUCTURE AND METHOD FOR MANUFACTURING VEHICLE ROOF STRUCTURE

(71) Applicant: AISIN CORPORATION, Kariya-shi (JP)

(72) Inventor: Taiki ASANO, Kariya-shi (JP)

(73) Assignee: AISIN CORPORATION, Kariya-shi (JP)

(21) Appl. No.: 18/453,130

(22) Filed: Aug. 21, 2023

(30) Foreign Application Priority Data
Aug. 25, 2022 (JP) 2022-133939
Jun. 26, 2023 (JP) 2023-104345

(51) Int. Cl. B60J 7/22; B60J 7/02; B60J 7/043

(52) U.S. Cl. CPC B60J 7/22; B60J 7/022; B60J 7/043

(57) ABSTRACT

A vehicle roof structure includes a frame and a deflector device. The frame defines an opening portion opened and closed by a movable panel. The deflector device includes a deflector and a torsion spring. The frame includes a first spring support portion supporting a first arm of the torsion spring in such a way as to be movable in a front-rear direction. The deflector includes a second spring support portion supporting a coil portion and a second arm of the torsion spring, and a holding portion that can hold the first arm. The first spring support portion includes a guide surface. Under a condition that the holding portion holds the first arm, when the deflector rotates toward a retracted position, the first arm slides on the guide surface, and is thereby shifted to a state of being supported by the first spring support portion.

### CROSS REFERENCE TO RELATED APPLICATIONS

This application is based on and claims priority under 35 U.S.C. § 119 to Japanese Patent Application No. 2022-133939, filed on Aug. 25, 2022 and Japanese Patent Application No. 2023-104345, filed on Jun. 26, 2023, the entire contents of which are incorporated herein by reference.

### TECHNICAL FIELD

This disclosure generally relates to a vehicle roof structure and a method for manufacturing a vehicle roof structure.

### BACKGROUND DISCUSSION

JP2012-106743A (Reference 1) describes a vehicle roof structure that includes a roof including an opening portion, a movable panel opening and closing the opening portion, and a deflector device reducing a wind noise being generated when a vehicle travels in a state where the opening portion is opened. The deflector device includes a deflector supported by the roof in such a way as to be swingable around an axis extending in a width direction, and a torsion spring including one arm fixed to the roof and another arm fixed to the deflector. When the movable panel opens the opening portion, the deflector device deploys, by restoration force of the torsion spring, the deflector to a position where a wind noise can be reduced.

A need thus exists for a vehicle roof structure, which is not susceptible to the drawback mentioned above

### SUMMARY

A vehicle roof structure according to one aspect of this disclosure includes a frame and a deflector device. The frame defines an opening portion that is opened and closed by a movable panel. The deflector device includes a deflector and a torsion spring. The deflector is supported in such a way as to be rotatable around an axis extending in a width direction, and rotates between a retracted position and a deployed position that is more displaced upward relative to the opening portion than the retracted position. The torsion spring includes a coil portion, a first arm that extends from a first end of the coil portion, and a second arm that extends from a second end of the coil portion, and is elastically compressed and deformed as the deflector is displaced from the deployed position toward the retracted position. The frame includes a first spring support portion that supports the first arm of the torsion spring in such a way as to be movable in a front-rear direction. The deflector includes a second spring support portion that supports the coil portion and the second arm of the torsion spring, and a holding portion that can hold the first arm. The first spring support portion includes a guide surface on which the first arm is slidable. Under a condition that the holding portion holds the first arm, when the deflector rotates toward the retracted position, the first arm slides on the guide surface, and is thereby shifted to a state of being supported by the first spring support portion.

A method for manufacturing a vehicle roof structure according to one aspect of this disclosure includes a spring temporary assembly step and a spring attachment step. The spring temporary assembly step includes causing a second spring support portion to support a coil portion and a second arm, and causing a holding portion to hold a first arm. The spring attachment step includes, after the spring temporary assembly step, rotating a deflector toward a retracted position, thereby causing the first arm to slide on a guide surface, and causing the first arm to be supported by a first spring support portion.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view of a vehicle roof structure;

FIG. 2 is a plan view of the vehicle roof structure;

FIG. 3 is an exploded perspective view of the vehicle roof structure;

FIG. 4 is a perspective view including a section taken along the line 4-4 in FIG. 2;

FIG. 5 is a perspective view of a deflector device for the vehicle roof structure;

FIG. 6 is a sectional view illustrating a manufacturing step for the vehicle roof structure;

FIG. 7 is a sectional view illustrating a manufacturing step for the vehicle roof structure;

FIG. 8 is a sectional view illustrating a manufacturing step for the vehicle roof structure;

FIG. 9 is a sectional view illustrating a manufacturing step for the vehicle roof structure;

FIG. 10 is a sectional view illustrating a manufacturing step for the vehicle roof structure;

FIG. 11 is a sectional view of a vehicle roof structure according to a first modified example;

FIG. 12 is a sectional view of a vehicle roof structure according to a second modified example; and

FIG. 13 is a sectional view of a vehicle roof structure according to a third modified example.

### DETAILED DESCRIPTION

The following describes one embodiment of a vehicle roof structure (hereinafter, referred to as “roof structure”) and a manufacturing method therefor. In the following description, a width direction, a front-rear direction, and an up-down direction of the roof structure are simply referred to as a width direction, a front-rear direction, and an up-down direction.

<Configuration of Present Embodiment>

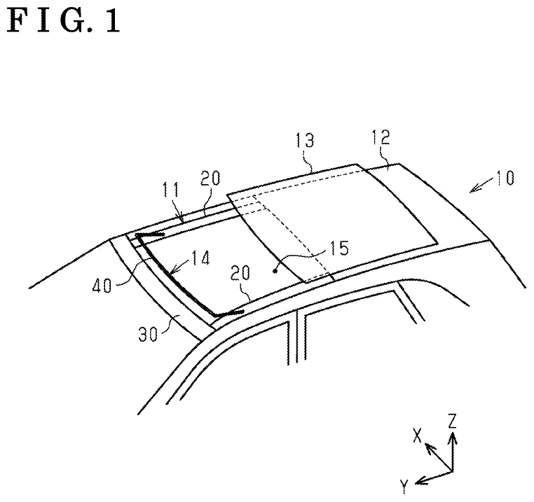

As illustrated in FIG. 1, the roof structure 10 includes a frame 11, a fixed panel 12, a movable panel 13, and a deflector device 14. The roof structure 10 includes an opening portion 15. The roof structure 10 has a structure symmetrical with respect to the width direction. In the following description, when there are two symmetrical configurations on a right side and on a left side in the width direction, the configuration on the right side will be described.

<Frame 11>

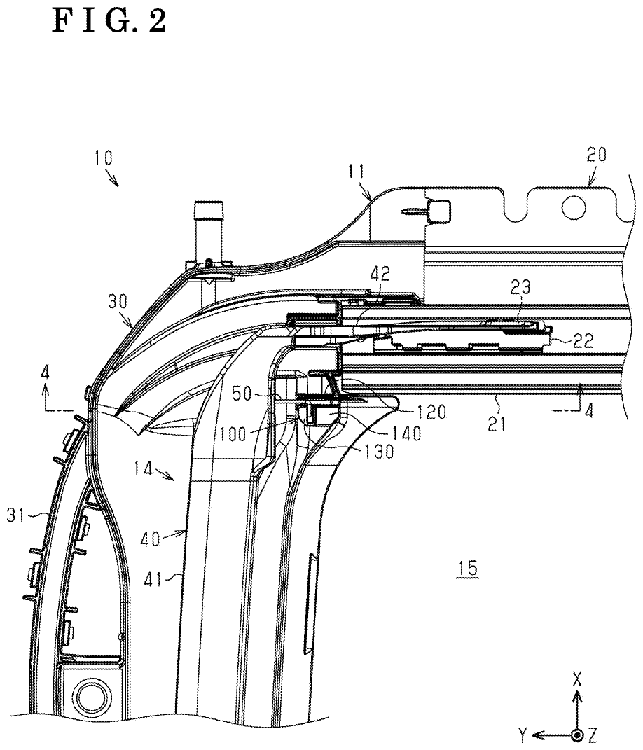

As illustrated in FIG. 1 and FIG. 2, the frame 11 includes two side frames 20 extending in the front-rear direction while being spaced from each other in the width direction, and a front frame 30 coupling front ends of the two side frames 20 to each other. The frame 11 defines the opening portion 15 by the two side frames 20 and the front frame 30. Although not illustrated in the drawings, the frame 11 may include a rear frame that couples rear ends of the two side frames 20 to each other, or may include a center frame that couples, to each other, intermediate portions of the two side frames 20 in the front-rear direction.

<Side Frame 20>

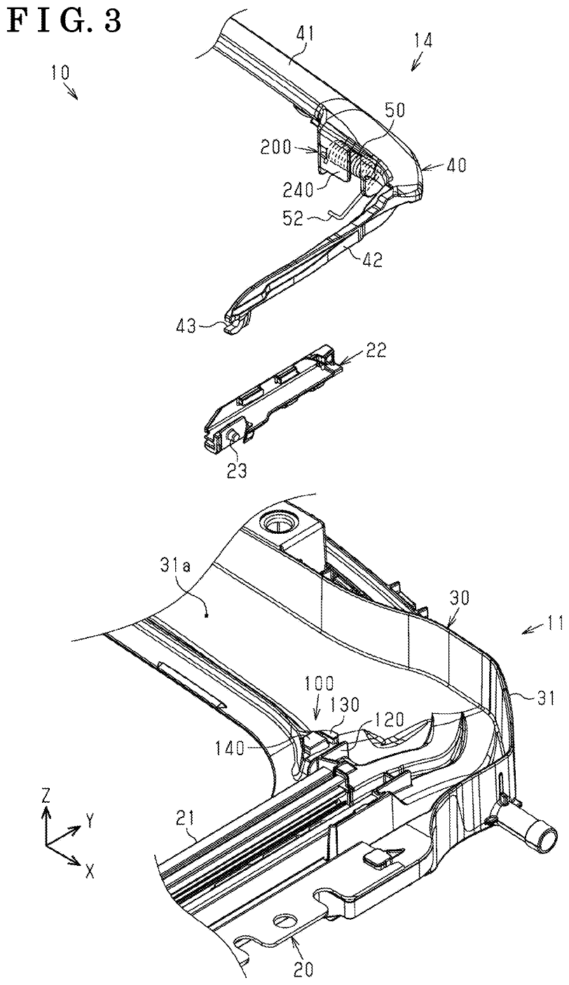

As illustrated in FIG. 3, the side frame 20 includes a guide rail 21 extending in the front-rear direction, and a deflector support portion 22 supporting constituent components of the deflector device 14. The guide rail 21 may be made of, for example, a metal material such as aluminum. The deflector support portion 22 has a substantially rectangular-parallelepiped shape. The deflector support portion 22 may be a resin molded product, for example. The deflector support portion 22 includes a support shaft 23 whose axial direction is the width direction. The support shaft 23 has a cylindrical shape. As illustrated in FIG. 2, the deflector support portion 22 is fixed near a front end of the guide rail 21.

<Front Frame 30>

As illustrated in FIG. 2 and FIG. 3, the front frame 30 includes a housing 31 and two first spring support portions 100. In the present embodiment, the front frame 30 may be a resin molded product. In this regard, the housing 31 and the two first spring support portions 100 are preferably molded integrally with each other.

A longitudinal direction of the housing 31 is the width direction. In a plan view from an upper side, both end portions of the housing 31 in the width direction are curved rearward. The housing 31 holds constituent components for driving the below-described movable panel 13. Both end portions of the housing 31 in the width direction are connected to the respective front ends of the two guide rails 21. The housing 31 includes an accommodation portion 31a. The accommodation portion 31a is a space recessed downward. In a plan view from an upper side, a longitudinal direction and a lateral direction of the accommodation portion 31a are the width direction and the front-rear direction, respectively. The housing 31 is positioned on a front side of the two first spring support portions 100.

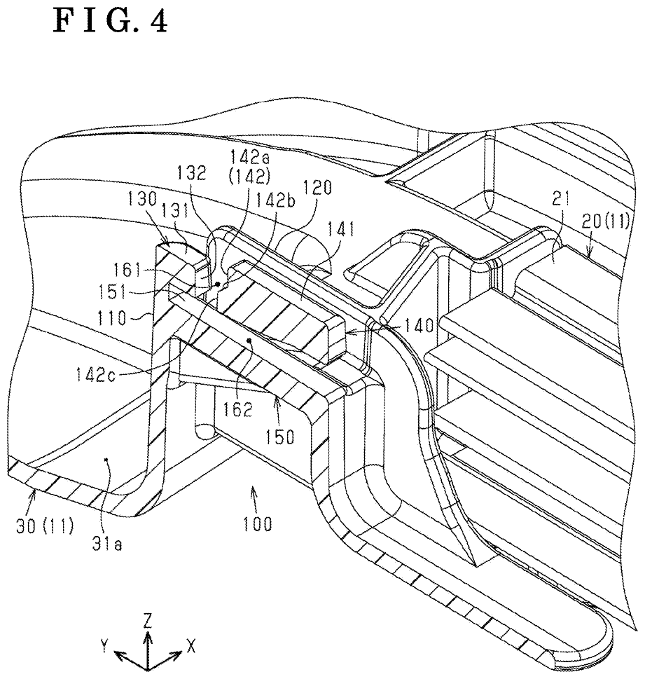

The two first spring support portions 100 are positioned on both sides in the housing 31 in the width direction. As illustrated in FIG. 4, the first spring support portion 100 includes a front wall 110 and a side wall 120 that extend upward from the housing 31, and a first upper wall 130, a second upper wall 140, and a lower wall 150 that are positioned on a rear side of the front wall 110. The first spring support portion 100 includes a communication groove 161 that is a groove between the first upper wall 130 and the second upper wall 140, and a slide space 162 that is a space between the lower wall 150 and each of the first upper wall 130 and the second upper wall 140.

A thickness direction of the front wall 110 is the front-rear direction, and a thickness direction of the side walls 120 is the width direction. The side wall 120 is positioned on an outer side of the front wall 110, the first upper wall 130, the second upper wall 140, and the lower wall 150 in the width direction. The front wall 110 defines a rear portion of the accommodation portion 31a. In other words, the front wall 110 extends upward from a bottom surface of the accommodation portion 31a. A gap exists between the side wall 120 and each of the first upper wall 130, the second upper wall 140, and the lower wall 150. This gap is connected to the communication groove 161 and the slide space 162 in the width direction.

The first upper wall 130 has a plate shape whose thickness direction is the up-down direction. The first upper wall 130 extends rearward from an upper end of the front wall 110. The first upper wall 130 includes a first upper surface 131 facing upward and a first rear surface 132 facing rearward. Both the first upper surface 131 and the first rear surface 132 have flat-surface shapes. The first upper wall 130 corresponds to “upper wall”, and the first upper surface 131 corresponds to “guide surface”.

The second upper wall 140 has a plate shape whose thickness direction is the up-down direction. The second upper wall 140 extends rearward while being spaced from the first upper wall 130 in the front-rear direction. The second upper wall 140 includes a second upper surface 141 facing upward and a second front surface 142 facing forward. The second upper surface 141 is positioned on an upper side of the first upper surface 131 in the up-down direction. In this regard, it can be said that the second upper wall 140 extends up to a position on an upper side of the first upper wall 130. The second front surface 142 includes a second front surface 142a that extends downward from a front end of the second upper surface 141, a second front surface 142b that extends downward from a lower end of the second front surface 142a while being shifted forward, and a second front surface 142c that extends downward from a lower end of the second front surface 142b. In the up-down direction, an upper end of the second front surface 142b is positioned at the substantially same height as an upper end of the first rear surface 132, and a lower end of the second front surface 142c is positioned at the substantially same height as a lower end of the first rear surface 132. In this regard, it can be said that the communication groove 161 is positioned between the first rear surface 132 and the second front surface 142. Although the first upper wall 130 and the second upper wall 140 are illustrated in FIG. 4 in such a way as to appear to be separated from each other, the first upper wall 130 and the second upper wall 140 are connected to each other at a position shifted in the width direction from the section illustrated in FIG. 4.

Similarly to the first upper wall 130 and the second upper wall 140, the lower wall 150 has a plate shape whose thickness direction is the up-down direction. The lower wall 150 extends rearward from the front wall 110, on a lower side of the first upper wall 130 and the second upper wall 140. In other words, the lower wall 150 faces the first upper wall 130 and the second upper wall 140 in the up-down direction. A length of the lower wall 150 in the front-rear direction is longer than a length of the first upper wall 130 in the front-rear direction. The lower wall 150 has a slide surface 151 facing upward. The slide surface 151 has a flat-surface shape. The slide surface 151 faces the slide space 162. The slide space 162 is connected to the communication groove 161.

<Fixed Panel 12>

As illustrated in FIG. 1, the fixed panel 12 is a panel that covers an area on a rear side of the opening 15. The fixed panel 12 is a non-displaceable panel, differently from the movable panel 13 described next. The fixed panel 12 is fixed to the frame 11 by using fastening components such as bolts or rivets.

<Movable Panel 13>

As illustrated in FIG. 1, the movable panel 13 is a panel that opens and closes the opening portion 15 of the roof structure 10. The movable panel 13 has a size depending on the opening portion 15 of the roof structure 10. The movable panel 13 is operated between a fully opening position of fully opening the opening portion 15 and a fully closing position of fully closing the opening portion 15, by an un-illustrated drive unit. For example, such a drive unit may be configured in such a way as to include an electric motor and a power transmission mechanism that converts rotational movement of an output shaft of the electric motor into forward and rearward movement of the movable panel 13.

In the present embodiment, an opening direction of the movable panel 13 is a rearward direction, and a closing direction of the movable panel 13 is a frontward direction. The movable panel 13 at the fully opening position may be positioned on an upper side of the fixed panel 12, or may be positioned on a lower side of the fixed panel 12. In other words, the movable panel 13 may be an outer slide type movable panel 13 or an inner slide type movable panel 13.

<Deflector Device 14>

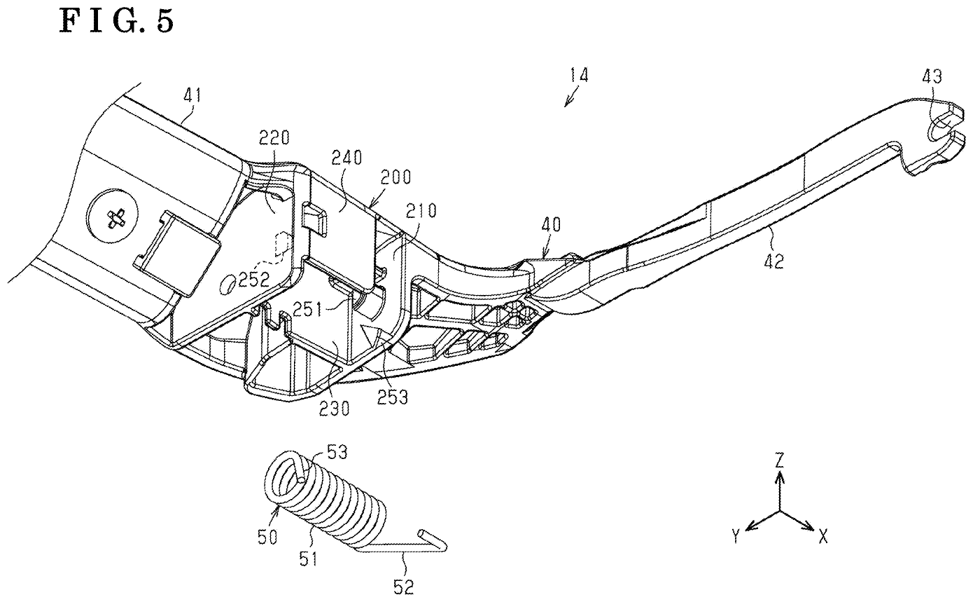

As illustrated in FIG. 3 and FIG. 5, the deflector device 14 includes a deflector 40 and a torsion spring 50.

The deflector 40 includes a deflector body 41, two deflector arms 42, and two second spring support portions 200. The deflector 40 may be a resin molded product, for example. The deflector 40 may be integrally molded, or may be configured by combining a plurality of components.

The deflector body 41 has a rod shape whose longitudinal direction is the width direction. A length of the deflector body 41 in the width direction is equivalent to a length of the opening portion 15 in the width direction. Preferably, the deflector body 41 is curved moderately relative to the width direction.

The two deflector arms 42 each have a shape of an elongated plate. The two deflector arms 42 extend from both end portions of the width direction in the deflector body 41. The deflector arm 42 includes a support hole 43 that engages with the support shaft 23 of the deflector support portion 22. Assuming that in a longitudinal direction of the deflector arm 42, an end portion connected to the deflector body 41 is a distal end, and an end portion opposite to the distal end is a proximal end, the support hole 43 is positioned at the proximal end of the deflector arm 42.

The two second spring support portions 200 are positioned on both sides in the deflector body 41 in the width direction. The second spring support portion 200 includes a first side wall 210 and a second side wall 220 that are spaced from each other in the width direction, a connection wall 230 that connects the first side wall 210 and the second side wall 220 to each other in the width direction, and a support wall 24 that extends from a rear end of the second side wall 220 toward the first side wall 210. The second spring support portion 200 includes a first support shaft 251 that extends from the first side wall 210 in the width direction, a second support shaft 252 that extends from the second side wall 220 in the width direction, and a holding portion 253 that extends from the first side wall 210 in the width direction.

The first side wall 210 and the second side wall 220 each have a plate shape whose plate thickness direction is the with the width direction. Meanwhile, the connection wall 230 and the support wall 240 each have a plate shape whose plate thickness direction is a direction perpendicular to the width direction. A thicknesses of each of the first support shaft 251 and the second support shaft 252 is set as a size depending on a size of the torsion spring 50. The holding portion 253 is positioned in such a way as to be spaced from the first support shaft 251. The holding portion 253 may have a cylindrical shape or a semi-cylindrical shape, or may have a polygonal column shape.

The torsion spring 50 includes a coil portion 51, a first arm 52 that extends from a first end of the coil portion 51, and a second arm 53 that extends from a second end of the coil portion 51. The first arm 52 extends in a tangential direction of the coil portion 51, and is then bent in an axial direction of the coil portion 51. In the following description, the bent part of the first arm 52 is referred to as a distal end of the first arm 52. In other words, the distal end of the first arm 52 does not mean a distal end surface of the first arm 52, but means the part that is in the first arm 52 and to which a load for elastically deforming the torsion spring 50 can be applied. The second arm 53 extends in a tangential direction of the coil portion 51. A diameter of the first arm 52 is smaller than each of a width of the communication groove 161 and a height of the slide space 162 in the first spring support portion 100. A length of the second arm 53 is shorter than a length of the first arm 52.

<Method for Manufacturing Roof Structure 10>

The following describes a method for manufacturing the roof structure 10. Concerning the method for manufacturing the roof structure 10, it is assumed that the components of the roof structure 10 are already prepared.

The method for manufacturing the roof structure 10 includes a spring temporary assembly step, a deflector attachment step, and a spring attachment step. In the following description, a configuration on one side in the roof structure 10 in the width direction is described.

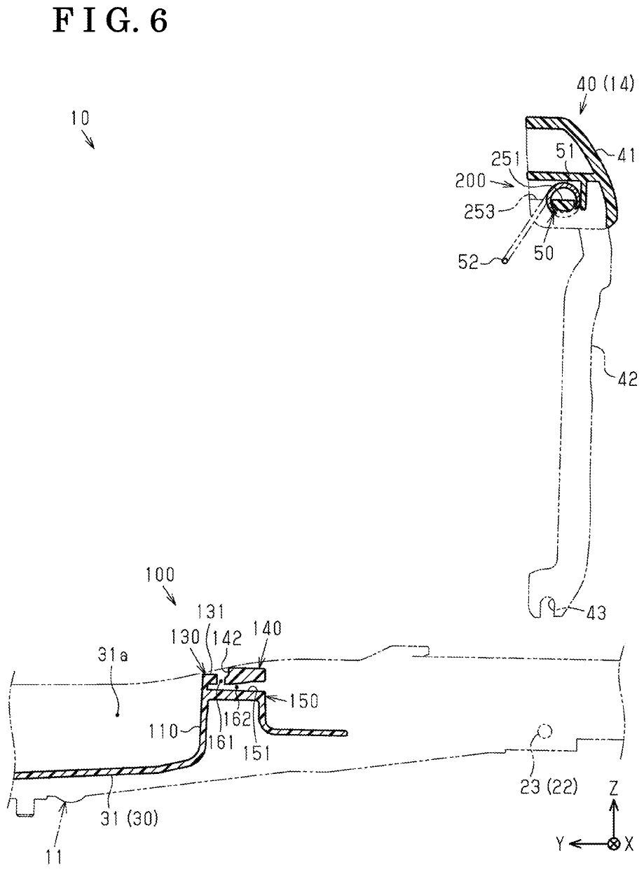

As illustrated in FIG. 5 and FIG. 6, at the spring temporary assembly step, the torsion spring 50 is temporarily assembled to the second spring support portion 200 of the deflector 40. Specifically, the coil portion 51 of the torsion spring 50 is disposed between the first side wall 210 and the second side wall 220 of the second spring support portion 200. At this time, the first support shaft 251 and the second support shaft 252 are inserted into respective both end portions of the coil portion 51 of the torsion spring 50. The first arm 52 of the torsion spring 50 contacts with the holding portion 253, and the second arm 53 of the torsion spring 50 contacts with the support wall 240. Thus, a state where the torsion spring 50 is temporarily assembled means a state where the coil portion 51 and the second arm 53 are supported by the second spring support portion 200, and the first arm 52 is held by the holding portion 253 of the second spring support portion 200.

The torsion spring 50 is elastically deformed in a state of being temporarily assembled to the second spring support portion 200. Specifically, the first arm 52 and the second arm 53 are relatively closer to each other in a peripheral direction of the coil portion 51, as compared to a state where no load is applied to the torsion spring 50. In the following description, such elastic deformation of the torsion spring 50 is referred to as “compressive deformation”.

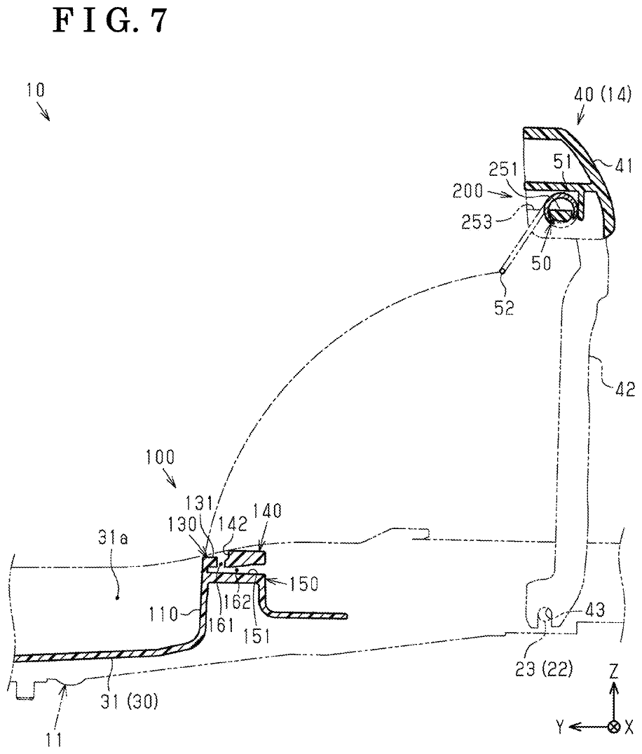

As illustrated in FIG. 7, at the deflector attachment step, the deflector 40 is attached to the deflector support portion 22 of the frame 11. Specifically, the proximal end of the deflector arm 42 is pressed against the support shaft 23 of the deflector support portion 22 in a state where the longitudinal direction of the deflector arm 42 is the up-down direction. Then, the support shaft 23 of the deflector support portion 22 is accommodated in the support hole 43 of the deflector arm 42. Thus, the deflector 40 is rotatable around the axis of the support shaft 23, i.e., around the axis extending in the width direction. When the deflector 40 is rotated around the axis of the support shaft 23, the distal end of the first arm 52 of the torsion spring 50 draws a rotation trajectory of a circular arc shape. Herein, the rotation trajectory of the distal end of the first arm 52 of the torsion spring 50 intersects with the first upper surface 131 of the first spring support portion 100.

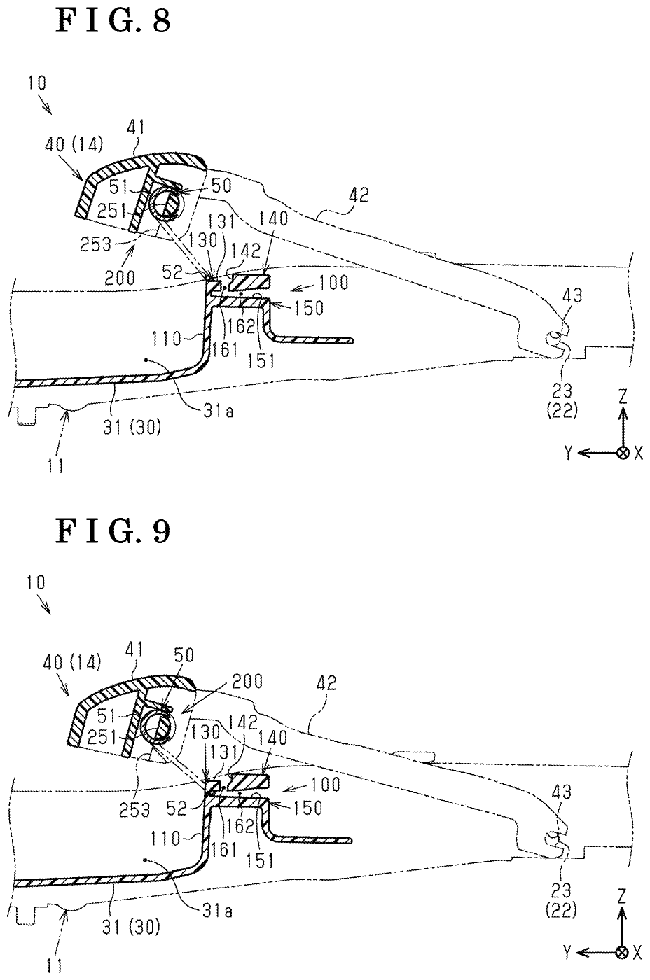

As illustrated in FIG. 8 and FIG. 9, at the spring attachment step, the first arm 52 of the torsion spring 50 shifts from a state of being held by the second spring support portion 200 to a state of being supported by the first spring support portion 100. At the spring assembly step, first, the deflector 40 is rotated in a direction of being inclined more deeply to a front side. Then, the distal end of the first arm 52 of the torsion spring 50 supported by the second spring support portion 200 contacts with the first upper surface 131 of the first upper wall 130 of the first spring support portion 100. At this time, the distal end of the first arm 52 is positioned on a lower side of a line segment that connects, to each other, the rotational axis of the deflector 40 and an axis passing through the center of the coil portion 51. Thus, when the deflector 40 is further rotated in the direction of being inclined more deeply to a front side, the distal end of the first arm 52 moves rearward while sliding on the first upper surface 131 of the first upper wall 130. When the distal end of the first arm 52 slides on the first upper surface 131, an amount of compressive deformation of the torsion spring 50 increases. Accordingly, the first arm 52 is separated from the holding portion 253 of the second spring support portion 200. In this regard, the holding portion 253 of the second spring support portion 200 can hold the first arm 52 until the first arm 52 contacts with the first spring support portion 100.

When the deflector 40 is further rotated in the direction of being inclined more deeply to a front side, the distal end of the first arm 52 of the torsion spring 50 moves to a rear end of the first upper wall 130. In other words, the distal end of the first arm 52 and the first upper surface 131 finish the sliding. Then, restoration force of the torsion spring 50 causes the distal end of the first arm 52 to be displaced downward while passing through the communication groove 161. As a result, the distal end of the first arm 52 contacts with the slide surface 151 of the lower wall 150, and thereby, the distal end of the first arm 52 is brought into a state of being slidable on the slide surface 151 of the lower wall 150. In other words, the distal end of the first arm 52 is accommodated in the slide space 162 between the lower wall 150 and each of the first upper wall 130 and the second upper wall 140. Thus, the distal end of the first arm 52 of the torsion spring 50 is supported by the first spring support portion 100 while the torsion spring 50 is kept compressed and deformed.

The restoration force of the torsion spring 50 causes the distal end of the first arm 52 to move not only downward but also forward. Thus, as illustrated in FIG. 9, the distal end of the first arm 52 is brought into a state of contacting with not only the slide surface 151 of the lower wall 150 but also the front wall 110.

A position of the deflector 40 illustrated in FIG. 9 indicates a position of the deflector 40 when the movable panel 13 is opened, i.e., the position of the deflector 40 when the deflector 40 is not pushed down by the movable panel 13. In other words, the position of the deflector 40 illustrated in FIG. 9 is “deployed position”.

In the present embodiment, as illustrated in FIG. 9, when the deflector 40 is set at the deployed position, the distal end of the first arm 52 of the torsion spring 50 contacts with the front wall 110 of the first spring support portion 100. Meanwhile, the first arm 52 of the torsion spring 50 is separated from the holding portion 253 of the second spring support portion 200.

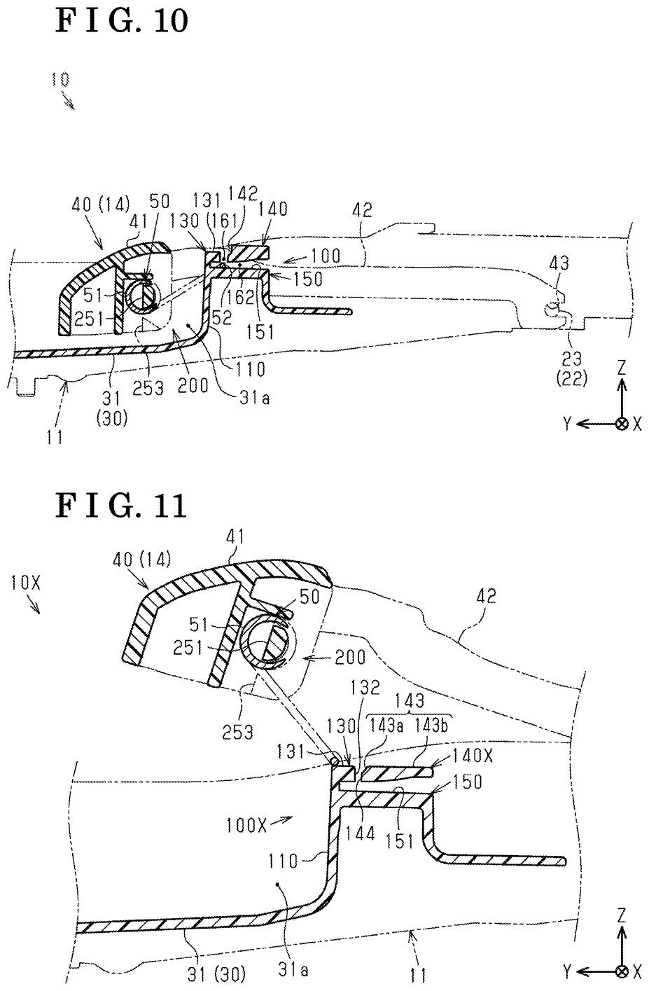

As illustrated in FIG. 9, when the distal end of the first arm 52 of the torsion spring 50 is supported by the first spring support portion 100, the spring attachment step is completed. When the rotation of the deflector 40 is continued in a state where the spring attachment step is completed, the deflector 40 is set at a retracted position illustrated in FIG. 10. The retracted position is a position closer to the frame 11 than the deployed position in the up-down direction. When the deflector 40 is set at the retracted position, the deflector body 41 is set in such a way as to be along the housing 31, and the two deflector arms 42 are set in such a way as to be along the two guide rails 21. The deflector body 41 is accommodated in the accommodation portion 31a of the housing 31.

<Effects of Present Embodiment>

The following describes a case where the movable panel 13 is opened from the fully closing position. When the movable panel 13 is positioned at the fully closing position, the movable panel 13 has pushed the deflector 40 down toward the frame 11. Thus, as illustrated in FIG. 10, the deflector 40 is set at the retracted position. When opening operation of the movable panel 13 is requested from a user of the vehicle, the movable panel 13 is opened toward the fully opening position. When the movable panel 13 is opened, the movable panel 13 is separated from the deflector 40, and thereby, the force pushing the movable panel 13 down toward the frame 11 is removed. As a result, due to the restoration force of the torsion spring 50, the deflector 40 is rotated from the retracted position illustrated in FIG. 10 to the deployed position illustrated in FIG. 9. Thus, the deflector 40 can adjust an airflow near a front end of the opening portion 15 when the vehicle travels. In other words, the deflector 40 can suppress a low-frequency noise that makes the user uncomfortable.

The following describes a case where the movable panel 13 is closed from the fully opening position. When the movable panel 13 is positioned at the fully opening position, the deflector 40 is set at the deployed position illustrated in FIG. 9, due to the restoration force of the torsion spring 50. When closing operation of the movable panel 13 is requested from the user of the vehicle, the movable panel 13 is operated in a closing direction. When the movable panel 13 reaches the vicinity of the fully closing position, the movable panel 13 starts to push the deflector 40 down toward the frame 11. As a result, the deflector 40 is rotated from the deployed position illustrated in FIG. 9 toward the retracted position illustrated in FIG. 10 while compressing and deforming the torsion spring 50. When the movable panel 13 reaches the fully closing position, the deflector 40 is set at the retracted position.

Both in the case where the deflector 40 is positioned at the deployed position illustrated in FIG. 9 and in the case where the deflector 40 is positioned at the retracted position illustrated in FIG. 10, the distal end of the first arm 52 of the torsion spring 50 is separated from the holding portion 253 of the second spring support portion 200. Thus, the holding portion 253 of the second spring support portion 200 does not affect movement of the deflector 40 between the retracted position and the deployed position.

As illustrated in FIG. 9 and FIG. 10, when the deflector 40 is rotated between the retracted position and the deployed position, in the front-rear direction, a position of the first spring support portion 100 does not change, and meanwhile, a position of the second spring support portion 200 changes. Thus, when the deflector 40 is rotated between the retracted position and the deployed position, the distal end of the first arm 52 of the torsion spring 50 moves along the slide surface 151 of the first spring support portion 100 in the front-rear direction. Thus, the first spring support portion 100 supports the distal end of the first arm 52 of the torsion spring 50 in such a way as to be movable in the front-rear direction.

<Effects of Present Embodiment>

(1) The torsion spring 50 can be temporarily assembled only to the second spring support portion 200 before the spring attachment step. Specifically, in addition to causing the coil portion 51 and the second arm 53 of the torsion spring 50 to be supported by the second spring support portion 200, the first arm 52 is caused to be held by the holding portion 253 of the second spring support portion 200 in a state where the torsion spring 50 is compressed and deformed. Accordingly, at the spring attachment step, a working person or a working apparatus does not need to cause the distal end of the first arm 52 of the torsion spring 50 to be supported by the first spring support portion 100 while compressing and deforming the torsion spring 50. In other words, at the spring attachment step, workability is improved at the time of causing the first arm 52 of the torsion spring 50 to be supported by the first spring support portion 100. Therefore, the roof structure 10 can reduce a labor required for the manufacturing.

(2) At the spring attachment step, the deflector 40 is rotated toward the retracted position while the first arm 52 of the torsion spring 50 is kept held by the holding portion 253, and thereby, the first arm 52 of the torsion spring 50 can be caused to be supported by the first spring support portion 100. Specifically, when the distal end of the first arm 52 slides on the first upper surface 131 of the first spring support portion 100, and thereby, the first arm 52 is separated from the holding portion 253, and the distal end of the first arm 52 is guided into the slide space 162 of the first spring support portion 100. Accordingly, a labor required for manufacturing the roof structure 10 is further reduced. The first spring support portion 100 can more firmly support the distal end of the first arm 52 of the torsion spring 50.

(3) At the spring attachment step, the distal end of the first arm 52 of the torsion spring 50 moves rearward while sliding on the first upper surface 131 of the first spring support portion 100. In this regard, the first spring support portion 100 includes, on a rear side of the first upper wall 130, the second upper wall 140 extending to an upper side of the first upper wall 130. Therefore, by the second upper wall 140, the first spring support portion 100 can restrict rearward movement of the distal end of the first arm 52 of the torsion spring 50. Thus, the first spring support portion 100 can guide the distal end of the first arm 52 of the torsion spring 50 toward the lower wall 150 via the communication groove 161.

Further, the second upper wall 140 includes the second front surface 142b that is inclined in such a way as to extend downward while being shifted forward. Thus, the first spring support portion 100 can more easily guide the distal end of the first arm 52 of the torsion spring 50 toward the lower wall 150.

(4) Under the condition that the deflector 40 is set at the deployed position, when external force of further rotating the deflector 40 in a deploying direction is applied, the first arm 52 of the torsion spring 50 contacts with the holding portion of the second spring support position 200. In other words, when external force of further rotating the deflector 40 from the deployed position in the deploying direction is applied, the holding portion 253 of the second spring support portion 200 can suppress rotation of the deflector 40 in the deploying direction.

### Modified Examples

The present embodiment can be modified and implemented as in the following. The present embodiment and the following modified examples can be implemented in combination with each other within a range where technical contradiction does not occur.
A configuration of the first spring support portion 100 can be appropriately modified. The following describes roof structures 10X, 10Y, and 10Z according to the modified examples with reference to FIG. 11 to FIG. 13. In the modified examples, the same configurations as those in the above-described embodiment are denoted by the same reference signs, and the description thereof is omitted.
As illustrated in FIG. 11, in the roof structure 10X, a first spring support portion 100X includes a front wall 110, the first upper wall 130, a second upper wall 140X, and the lower wall 150. The second upper wall 140X includes a second upper surface 143 that faces upward, and a second front surface 144 that faces forward. In the up-down direction, the second upper surface 143 is positioned at the same height as that of the first upper surface 131. The second upper surface 143 includes a second upper surface 143a that extends upward while being shifted rearward, and a second upper surface 143b that extends rearward from an rear end of the second upper surface 143a. In other words, a front end portion of the second upper wall 140X is beveled. The second upper surface 143a corresponds to “second inclined surface”.

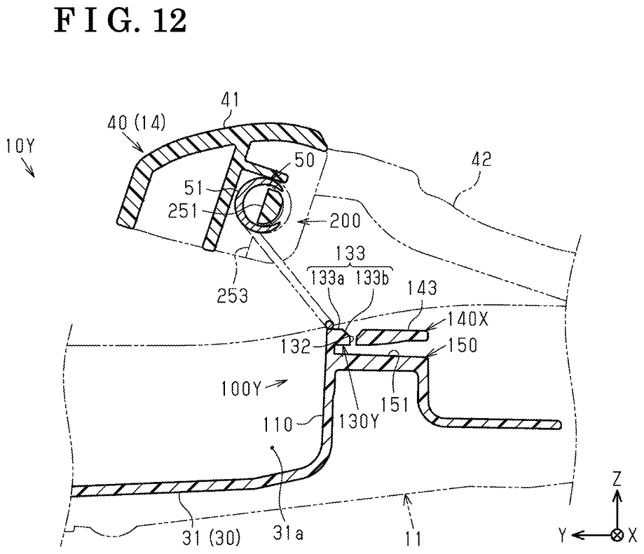

The following considers a case where the distal end included in the first arm 52 of the torsion spring 50 and moving rearward comes into contact with the second upper wall 140X at the spring attachment step. Herein, the second upper surface 143 of the second upper wall 140X includes the second upper surface 143a that is inclined toward the lower wall 150. Thus, in the above-described case, the first spring support portion 100X can guide the distal end of the first arm 52 of the torsion spring 50 toward the lower wall 150.
As illustrated in FIG. 12, in the roof structure 10Y, a first spring support portion 100Y includes the front wall 110, a first upper wall 130Y, the second upper wall 140X, and the lower wall 150. The first upper wall 130Y includes a first upper surface 133 that faces upward, and a first rear surface 132 that faces rearward. The first upper surface 133 includes a first upper surface 133a that extends rearward, and a first upper surface 133b that extends downward from a rear end of the first upper surface 133a while being shifted rearward. In other words, a rear end portion of the first upper wall 130Y is beveled. The first upper surface 133b corresponds to “first inclined surface”.

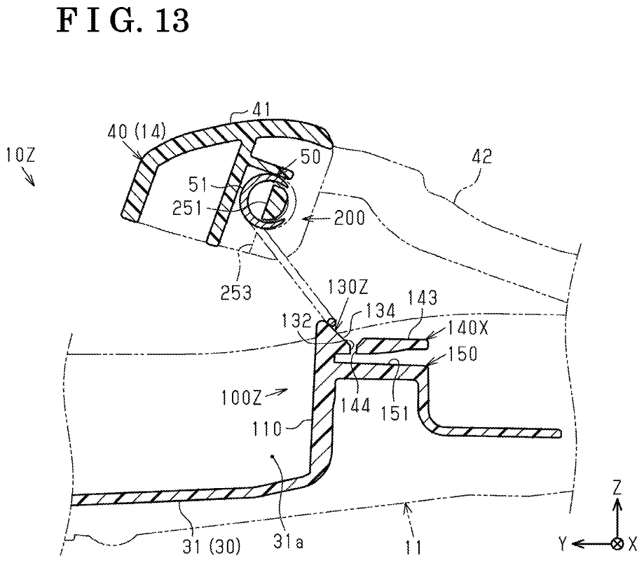

At the spring attachment step, the distal end of the first arm 52 of the torsion spring 50 moves rearward while sliding on the first upper surface 133 of the first spring support portion 100Y. Herein, the first upper surface 133 includes the first upper surface 133b that is inclined toward the lower wall 150. Thus, the first spring support portion 100Y can guide the distal end of the first arm 52 of the torsion spring 50 toward the lower wall 150.
As illustrated in FIG. 13, in the roof structure 10Z, a first spring support portion 100Z of the housing 31 includes the front wall 110, a first upper wall 130Z, the second upper wall 140X, and the lower wall 150. The first upper wall 130Z includes a first upper surface 134 that faces upward, and a first rear surface 132 that faces rearward. The first upper surface 134 extends downward while being shifted rearward. Under the condition that the holding portion 253 of the second spring support portion 200 holds the first arm 52 of the torsion spring 50, the first upper surface 134 of the first upper wall 130 intersects with the trajectory of the distal end of the first arm 52 when the deflector 40 is rotated. The first upper surface 134 corresponds to “guide surface” and the “first inclined surface”.

When the deflector 40 is rotated toward the retracted position at the spring attachment step, the distal end of the first arm 52 of the torsion spring 50 contacts with the first upper surface 134. Subsequently, when the deflector 40 is further rotated toward the retracted position, the distal end of the first arm 52 of the torsion spring 50 moves toward the communication groove 161 while sliding on the first upper surface 134. Thus, the first spring support portion 100Z can more reliably guide the distal end of the first arm 52 of the torsion spring 50 toward the lower wall 150.
The torsion spring 50 may be a double torsion spring.
A shape of the first spring support portion 100 can be appropriately modified. For example, the first spring support portion 100 may have a configuration that can support the distal end of the first arm 52 of the torsion spring 50 at the spring attachment step while maintaining elastic deformation of the torsion spring 50 held by the holding portion 253 of the second spring support portion 200.
The first spring support portion 100 does not need to include the second upper wall 140.
In the above-described embodiment, the first arm 52 of the torsion spring 50 contacts with the front wall 110 of the first spring support portion 100, and thereby, the deployed position of the deflector 40 is defined, but the deployed position of the deflector 40 may be defined by another method. For example, the first arm 52 of the torsion spring 50 may be caused to contact with the holding portion 253 of the second spring support portion 200, and thereby, the deployed position of the deflector 40 may be defined. In other words, after the spring attachment step, the holding portion 253 of the second spring support portion 200 may contact with the first arm 52 of the torsion spring 50.
At the spring attachment step in the above-described embodiment, the distal end of the first arm 52 of the torsion spring 50 contacts with the first upper surface 131 of the first upper wall 130 of the first spring support portion 100. In other words, the rotation trajectory of the distal end of the first arm 52 intersects with the first upper surface 131. In the modified example, the rotation trajectory of the distal end of the first arm 52 may pass through the communication groove 161 between the first upper wall 130 and the second upper wall 140, and may intersect with the slide surface 151 of the lower wall 150. In this case, at the spring attachment step, the distal end of the first arm 52 contacts with the lower wall 150 without contacting with the first upper wall 130 and the second upper wall 140. In other words, it can be said that the lower wall 150 includes a surface corresponding to “guide surface”, in addition to the slide surface 151. In this case, the slide surface 151 and the guide surface may share a part thereof.
The holding portion 253 of the second spring support portion 200 may hold the first arm 52 in such a way that the torsion spring 50 is not elastically deformed. In this case, preferably, a gap between the holding portion 253 and the first arm 52 is set small in such a way that the torsion spring 50 does not inadvertently move relative to the second spring support portion 200.
The numbers of the first spring support portions 100 and the second spring support portions 200 can be appropriately modified. For example, the front frame 30 may include one first spring support portion 100 at a central portion in the width direction. In this case, the deflector 40 may include one second spring support portion 200 in a central portion in the width direction.
Structures of the first spring support portion 100 and the second spring support portion 200 can be appropriately modified. For example, as illustrated in FIG. 7, in the torsion spring 50 of the above-described embodiment, the distal end of the first arm 52 is positioned closer to the rotation center of the deflector 40 than the coil portion 51. In other words, the first arm 52 held by the holding portion 253 extends toward the proximal end portion of the deflector 40 relative to the coil portion 51 while being shifted in a retracting direction of the deflector 40. In contrast to this, in the torsion spring 50 of the modified example, the coil portion 51 may be positioned closer to the rotation center of the deflector 40 than the distal end of the first arm 52. In other words, the first arm 52 held by the holding portion 253 may extend toward the distal end portion of the deflector 40 relative to the coil portion 51 while being shifted in the retracting direction of the deflector 40. The first spring support portion 100 does not need to include the front wall 110, and in the first spring support portion 100, the lower wall 150 may extend to a front side of the first upper wall 130.

In such a case, when the deflector 40 is rotated at the spring attachment step, the distal end of the first arm 52 held by the holding portion 253 moves forward while sliding on the first upper surface 131 of the first upper wall 130. Then, when the distal end of the first arm 52 of the torsion spring 50 moves to a front end of the first upper wall 130, the restoration force of the torsion spring 50 causes the distal end of the first arm 52 to be displaced downward. As a result, the distal end of the first arm 52 contacts with the slide surface 151 of the lower wall 150, and thereby, the distal end of the first arm 52 is brought into a state of being slidable on the slide surface 151 of the lower wall 150. In other words, the distal end of the first arm 52 of the torsion spring 50 is supported by the first spring support portion 100.
The first spring support portion 100 may be provided in the side frame 20 that constitutes the frame 11. In this case, the second spring support portion 200 may be provided in the deflector arm 42.
In the deflector 40, the second spring support portion 200 does not need to include the holding portion 253. In this case, preferably, the deflector 40 includes the holding portion 253 at a part different from the second spring support portion 200. In this case, preferably, a shape of the torsion spring 50 is modified depending on a position of the holding portion 253.

The following describes means in order to solve the above-described problem and its advantageous effect.

[Aspect 1] A vehicle roof structure that solves the above-described problem includes a frame and a deflector device. The frame defines an opening portion that is opened and closed by a movable panel. The deflector device includes a deflector and a torsion spring. The deflector is supported in such a way as to be rotatable around an axis extending in a width direction, and rotates between a retracted position and a deployed position that is more displaced upward relative to the opening portion than the retracted position. The torsion spring includes a coil portion, a first arm that extends from a first end of the coil portion, and a second arm that extends from a second end of the coil portion, and is elastically compressed and deformed as the deflector is displaced from the deployed position toward the retracted position. The frame includes a first spring support portion that supports the first arm of the torsion spring in such a way as to be movable in a front-rear direction. The deflector includes a second spring support portion that supports the coil portion and the second arm of the torsion spring, and a holding portion that can hold the first arm. The first spring support portion includes a guide surface on which the first arm is slidable. Under a condition that the holding portion holds the first arm, when the deflector rotates toward the retracted position, the first arm slides on the guide surface, and is thereby shifted to a state of being supported by the first spring support portion.

In the vehicle roof structure, when the movable panel closes the opening portion, the movable panel pushes down the deflector. Thus, the deflector is set at the retracted position while compressing and deforming the torsion spring. Meanwhile, when the movable panel opens the opening portion, the movable panel is separated from the deflector. Thus, the deflector is set at the deployed position by restoration force of the torsion spring.

In a case of manufacturing the vehicle roof structure, the first arm and the second arm of the torsion spring need to be supported by the first spring support portion of the frame and the second spring support portion of the deflector, respectively. According to the above-described configuration, the torsion spring can be temporarily assembled only to the second spring support portion before a spring attachment step of causing the first arm of the torsion spring to be supported by the first spring support portion. Specifically, the coil portion and the second arm of the torsion spring are caused to be supported by the second spring support portion, and in addition, the first arm can be caused to be held by the holding portion of the second spring support portion.

Thus, at the spring attachment step, when the deflector is rotated toward the retracted position while the first arm of the torsion spring is kept held by the holding portion of the second spring support portion, the first arm slides on the guide surface of the first spring support portion. Then, accompanying sliding between the first arm of the torsion spring and the guide surface of the first spring support portion, the first arm is brought into a state of being supported by the first spring support portion. Accordingly, merely rotating the deflector toward the retracted position at the spring attachment step causes the first arm of the torsion spring to be supported by the first spring support portion. Therefore, the vehicle roof structure can reduce a labor required for the manufacturing.

[Aspect 2] In the vehicle roof structure according to the aspect 1, the first spring support portion may include an upper wall and a lower wall. The upper wall includes the guide surface and extends in the front-rear direction. The lower wall is positioned on a lower side than the upper wall and extends longer in the front-rear direction than the upper wall. The first spring support portion may support the first arm between the upper wall and the lower wall. Under a condition that the holding portion holds the first arm, when the deflector rotates toward the retracted position, the guide surface may guide the first arm to a front side of a front end of the upper wall or to a rear side of a rear end of the upper wall.

At the spring attachment step, when the deflector is rotated toward the retracted position while the first arm of the torsion spring is kept held by the holding portion of the second spring support portion, the first arm slides on the guide surface of the first spring support portion. When, accompanying sliding between the first arm of the torsion spring and the guide surface of the first spring support portion, the first arm moves to a front side of the front end of the upper wall of the first spring support portion or to a rear side of the rear end of the upper wall, the first arm is displaced toward the lower wall of the first spring support portion. In other words, the first arm of the torsion spring is guided to an area between the upper wall and the lower wall of the first spring support portion. Thus, even in a case of adopting the configuration in which the first spring support portion supports the first arm of the torsion spring between the upper wall and the lower wall, merely rotating the deflector toward the retracted position at the spring attachment step can cause the first arm to be supported by the first spring support portion.

[Aspect 3] In the vehicle roof structure according to the aspect 2, when the upper wall is defined as a first upper wall, the first spring support portion may include a second upper wall that extends rearward in a state of being spaced from a rear end of the first upper wall. The second upper wall may extend to an upper side than the first upper wall. Under a condition that the holding portion holds the first arm, when the deflector rotates toward the retracted position, the guide surface may guide the first arm to a rear side of a rear end of the first upper wall.

At the spring attachment step, the first arm of the torsion spring moves rearward while sliding on the guide surface of the first spring support portion. In this regard, the first spring support portion of the above-described configuration includes the second upper wall positioned on a rear side of the first upper wall and extending to an upper side than the first upper wall. For this reason, the first spring support portion can restrict rearward movement of the first arm of the torsion spring by the second upper wall. Thus, the first spring support portion can guide the first arm of the torsion spring toward the lower wall via a gap between the first upper wall and the second upper wall.

[Aspect 4] In the vehicle roof structure according to the aspect 3, a second upper surface being included in the second upper wall and facing upward may include a second inclined surface that is inclined in such a way as to extend downward while being shifted forward.

The following considers a case where the first arm of the torsion spring moving rearward comes into contact with the second upper wall at the spring attachment step. Herein, the second upper surface of the second upper wall includes the second inclined surface that is inclined toward the lower wall. Thus, the first spring support portion can guide the first arm of the torsion spring toward the lower wall in the above-described case.

[Aspect 5] In the vehicle roof structure according to the aspect 3 or 4, the guide surface of the first upper wall may include a first inclined surface that is inclined in such a way as to extend downward while being shifted rearward.

At the spring attachment step, the first arm of the torsion spring moves rearward while sliding on the guide surface of the first spring support portion. Herein, the guide surface includes the first inclined surface that is inclined toward the lower wall. Thus, the first spring support portion can guide the first arm of the torsion spring toward the lower wall.

[Aspect 6] In the vehicle roof structure according to the aspect 5, under a condition that the holding portion holds the first arm, the first inclined surface of the upper wall may intersect with a rotation trajectory of the first arm when the deflector rotates toward the retracted position.

When the deflector is rotated toward the retracted position at the spring attachment step, the first arm of the torsion spring contacts with the first inclined surface, and then slides on the first inclined surface. Thus, the first spring support portion can more reliably guide the first arm of the torsion spring toward the lower wall.

[Aspect 7] In the vehicle roof structure according to any one of the aspects 1 to 6, the holding portion may hold the first arm in a state of making the torsion spring elastically compressed and deformed.

According to the above-described configuration, the torsion spring can be temporarily assembled only to the second spring support portion before the spring attachment step of causing the first arm of the torsion spring to be supported by the first spring support portion. Specifically, the coil portion and the second arm of the torsion spring are caused to be supported by the second spring support portion, and in addition, the first arm can be caused to be held by the holding portion of the second spring support portion in a state where the torsion spring is compressed and deformed. Accordingly, at the spring attachment step, a working person or a working apparatus does not need to cause the first arm to be supported by the first spring support portion while largely compressing and deforming the torsion spring. In other words, workability is further improved at a time of causing the first arm of the torsion spring to be supported by the first spring support portion.

[Aspect 8] A method for manufacturing the vehicle roof structure that can solve the above-described problem includes a spring temporary assembly step and a spring attachment step. The spring temporary assembly step includes causing the second spring support portion to support the coil portion and the second arm, and causing the holding portion to hold the first arm. The spring attachment step includes, after the spring temporary assembly step, rotating the deflector toward the retracted position, thereby causing the first arm to slide on the guide surface, and causing the first arm to be supported by the first spring support portion.

The method for manufacturing the vehicle roof structure can achieve an advantageous effect equivalent to that of the above-described vehicle roof structure.

[Aspect 9] In the method for manufacturing the vehicle roof structure according to the aspect 8, the first spring support portion may include an upper wall including the guide surface and extending in a front-rear direction, and a lower wall positioned on a lower side than the upper wall and extending longer in the front-rear direction than the upper wall. Under a condition that the holding portion holds the first arm, when the deflector rotates toward the retracted position, the guide surface may guide the first arm to a front side of a front end of the upper wall or to a rear side of a rear end of the upper wall. The spring attachment step may include causing the first arm to slide on the guide surface, and thereby setting the first arm between the upper wall and the lower wall of the first spring support portion.

The method for manufacturing the vehicle roof structure can achieve an advantageous effect equivalent to that of the above-described vehicle roof structure.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A vehicle roof structure comprising:
a frame defining an opening portion that is opened and closed by a movable panel; and
a deflector device including a deflector and a torsion spring, the deflector being supported in such a way as to be rotatable around an axis extending in a width direction, the deflector rotating between a retracted position and a deployed position that is more displaced upward relative to the opening portion than the retracted position, the torsion spring including a coil portion, a first arm that extends from a first end of the coil portion, and a second arm that extends from a second end of the coil portion, the torsion spring being elastically compressed and deformed as the deflector is displaced from the deployed position toward the retracted position, wherein
the frame includes a first spring support portion that supports the first arm of the torsion spring in such a way as to be movable in a front-rear direction,
the deflector includes a second spring support portion that supports the coil portion and the second arm of the torsion spring, and a holding portion that can hold the first arm,
the first spring support portion includes a guide surface on which the first arm is slidable, and,
under a condition that the holding portion holds the first arm, when the deflector rotates toward the retracted position, the first arm slides on the guide surface, and is thereby shifted to a state of being supported by the first spring support portion.

2. The vehicle roof structure according to claim 1, wherein
the first spring support portion includes an upper wall including the guide surface and extending in the front-rear direction, and a lower wall being positioned on a lower side than the upper wall and extending longer in the front-rear direction than the upper wall, and supports the first arm between the upper wall and the lower wall, and,
under a condition that the holding portion holds the first arm, when the deflector rotates toward the retracted position, the guide surface guides the first arm to a front side of a front end of the upper wall or to a rear side of a rear end of the upper wall.

3. The vehicle roof structure according to claim 2, wherein,
when the upper wall is defined as a first upper wall,
the first spring support portion includes a second upper wall that extends rearward in a state of being spaced from a rear end of the first upper wall,
the second upper wall extends to an upper side than the first upper wall, and,
under a condition that the holding portion holds the first arm, when the deflector rotates toward the retracted position, the guide surface guides the first arm to a rear side of a rear end of the first upper wall.

4. The vehicle roof structure according to claim 3, wherein
a second upper surface being included in the second upper wall and facing upward includes a second inclined surface that is inclined in such a way as to extend downward while being shifted forward.

5. The vehicle roof structure according to claim 3, wherein
the guide surface of the first upper wall includes a first inclined surface that is inclined in such a way as to extend downward while being shifted rearward.

6. The vehicle roof structure according to claim 5, wherein,
under a condition that the holding portion holds the first arm, the first inclined surface of the upper wall intersects with a rotation trajectory of the first arm when the deflector rotates toward the retracted position.

7. The vehicle roof structure according to claim 1, wherein
the holding portion holds the first arm in a state of making the torsion spring elastically compressed and deformed.

8. A method for manufacturing the vehicle roof structure according to claim 1, comprising:
a spring temporary assembly step of causing the second spring support portion to support the coil portion and the second arm, and causing the holding portion to hold the first arm; and
a spring attachment step of, after the spring temporary assembly step, rotating the deflector toward the retracted position, thereby causing the first arm to slide on the guide surface, and causing the first arm to be supported by the first spring support portion.

9. The method for manufacturing the vehicle roof structure according to claim 8, wherein
the first spring support portion includes an upper wall including the guide surface and extending in a front-rear direction, and a lower wall being positioned on a lower side than the upper wall and extending longer in the front-rear direction than the upper wall,
under a condition that the holding portion holds the first arm, when the deflector rotates toward the retracted position, the guide surface guides the first arm to a front side of a front end of the upper wall or to a rear side of a rear end of the upper wall, and
the spring attachment step includes causing the first arm to slide on the guide surface, and thereby setting the first arm between the upper wall and the lower wall of the first spring support portion.

10. The vehicle roof structure according to claim 4, wherein
the guide surface of the first upper wall includes a first inclined surface that is inclined in such a way as to extend downward while being shifted rearward.

11. The vehicle roof structure according to claim 10, wherein,
under a condition that the holding portion holds the first arm, the first inclined surface of the upper wall intersects with a rotation trajectory of the first arm when the deflector rotates toward the retracted position.

12. The vehicle roof structure according to claim 2, wherein
the holding portion holds the first arm in a state of making the torsion spring elastically compressed and deformed.

13. The vehicle roof structure according to claim 3, wherein
the holding portion holds the first arm in a state of making the torsion spring elastically compressed and deformed.

14. The vehicle roof structure according to claim 4, wherein
the holding portion holds the first arm in a state of making the torsion spring elastically compressed and deformed.
